(19) United States
(12) Patent Application Publication
(10) Pub. No.: US 2009/0206680 A1
(43) Pub. Date: Aug. 20, 2009

(54) Apparatus for Suppressing Mid-Frequency Noise in an Integrated Circuit Having Multiple Voltage Islands

(76) Inventors: Sungjun Chun, Austin, TX (US); Anand Haridass, Austin, TX (US); Jesus Montanez, Austin, TX (US); Xiaomin Shen, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 12/031,762

(22) Filed: Feb. 15, 2008

(51) Int. Cl. H02H 3/00

(52) U.S. Cl. 307/130

(57) ABSTRACT

An apparatus for suppressing mid-frequency noise in an integrated circuit having multiple voltage islands is disclosed. Voltage rails powered at higher nominal voltages are selectively connected to voltage rails powered at lower nominal voltages via controlled gates. During operation, a voltage rail in which voltage has decreased below a pre-determined threshold is coupled to a voltage rail powered at a higher nominal voltage for a pre-selected time interval.

### BACKGROUND OF THE INVENTION

1. Technical Field

The present invention relates to integrated circuits in general, and in particular to integrated circuits having multiple voltage islands. Still more particularly, the present invention relates to an apparatus for suppressing mid-frequency noise in an integrated circuit having multiple voltage islands.

2. Description of Related Art

Simultaneous switching of a large number of transistors within an integrated circuit may result in rail voltage fluctuations within the integrated circuit. In addition, if a rail voltage of the integrated circuit decreases below a certain level, the integrated circuit may become inoperable. Such switching-induced fluctuations of rail voltages are commonly referred to as “mid-frequency noise” and are particularly difficult to mitigate in integrated circuits having multiple voltage islands (i.e., circuit blocks powered by different rail voltages).

Early techniques for suppressing mid-frequency noise within an integrated circuit having multiple voltage islands mainly focus on the usage of additional on-chip storage capacitors to compensate for intermittent drops of rail voltages. However, this approach comes with penalties in the form of real estate and leakage-related power losses in storage capacitors, and such penalties increase with the number of voltage islands being utilized on the integrated circuit.

Consequently, it would be desirable to provide an improved apparatus for suppressing mid-frequency noise within an integrated circuit having multiple voltage islands.

### SUMMARY OF THE INVENTION

In accordance with a preferred embodiment of the present invention, an apparatus for suppressing mid-frequency noise in an integrated circuit having multiple voltage islands includes a control gate, a sensing circuit, and a decision circuit. The control gate is utilized to connect a voltage tab of a first voltage rail associated with a first voltage island to a voltage tab of a second voltage rail associated with a second voltage island. The first voltage rail is powered by a lower nominal voltage than the second voltage rail. The sensing circuit monitors voltages at the voltage tab of the first voltage rail as well as voltages at the voltage tab of the second voltage rail. If the voltages at the voltage tab of the first voltage rail have decreased below a first pre-determined threshold, the decision circuit enables the controlled gate to couple the two voltage tabs for a first pre-selected time interval. If the voltages at the voltage tab of the first voltage rail have exceeded a second pre-determined threshold, the decision circuit enables the controlled gate to couple the two voltage tabs for a second pre-selected time interval. If the voltages at the voltage tab of the second voltage rail have decreased below a third pre-determined threshold, the decision circuit enables the controlled gate to couple the two voltage tabs for a third pre-selected time interval. If the voltages at the voltage tab of the second voltage rail have exceeded a fourth pre-determined threshold, the decision circuit enables the controlled gate to couple the two voltage tabs for a fourth pre-selected time interval.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a schematic diagram of an integrated circuit having an apparatus for suppressing mid-frequency noise, in accordance with a preferred embodiment of the present invention;

FIG. 2 is a high-level logic flow diagram of a method for suppressing mid-frequency noise in the integrated circuit from FIG. 1, in accordance with a preferred embodiment of the present invention; and

FIG. 3 is a timing diagram illustrating various tab voltages of the integrated circuit from FIG. 1

### DETAILED DESCRIPTION OF A PREFERRED EMBODIMENT

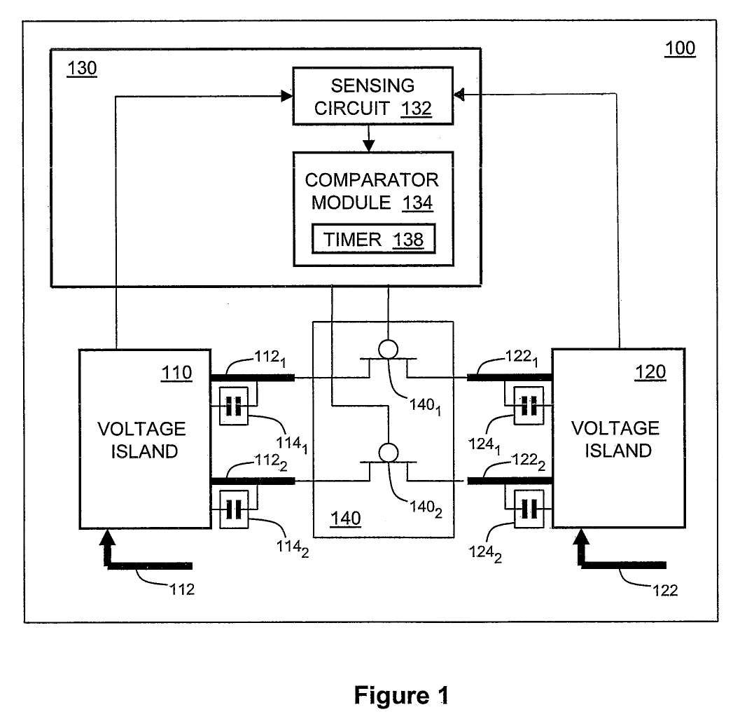

With reference now to the drawings, and in particular to FIG. 1, there is depicted an integrated circuit having an apparatus for suppressing mid-frequency noise, in accordance with a preferred embodiment of the present invention. As shown, an integrated circuit 100 includes voltage islands 110 and 120. Voltages V1 and V2 are provided to voltage islands 110 and 120 via voltage rails 112 and 122, respectively. Each of voltage rails 112 and 122 may include multiple voltage tabs that are powered by the same rail voltage. In the present embodiment, each of voltage rails 112 and 122 includes two voltage tabs. For example, voltage rail 112 includes voltage tabs 112₁ and 112₂, and voltage rail 122 includes voltage tabs 122₁ and 122₂.

Integrated circuit 100 also includes a decision circuit 130 and a control gate 140. Control gate 140, which is controlled by decision circuit 130, includes a gate 140₁ and a gate 140₂. Voltage tabs 112₁, 112₂ from voltage rail 112 and voltage tabs 122₁, 122₂ from voltage rail 122 having different nominal values are connected to each other by control gate 140 in a manner that a voltage tab having a lower nominal voltage is selectively connected to a voltage tab having a higher nominal voltage. In the present embodiment, voltage tab 112₁ is connected to tab 122₁ via gate 140₁, and voltage tab 112₂ is connected to tab 122₂ via gate 140₂.

Each of voltage tabs 112₁, 112₂, 122₁ and 122₂ is associated with a set of discrete charge storage elements. The discrete charge storage elements generally include on-chip and/or on-module decoupling capacitors, which are connected to a respective voltage tab or rail of integrated circuit 100. Correspondingly, the discrete charge storage elements are formed by on-chip added capacitances of the voltage tab and the voltage rail, as well as the parasitic capacitances of circuit elements of a respective voltage island and elements of a package of integrated circuit 100. These discrete charge storage elements collectively perform as equivalent capacitors coupled to the respective voltage tab. For example, the equivalent capacitors that are associated with voltage tabs 112₁, 112₂ of voltage rail 112 and voltage tabs 121₂, 122₂ of voltage rail 122 are illustratively shown as capacitors 114₁, 114₂ and 124₁, 124₂, respectively.

Due to geometrical proximity of voltage islands 110 and 120 with each another, the charge accumulated by the equivalent capacitor associated with a tab of one voltage island may be discharged into a tab of another voltage island having a lower nominal tab voltage, which increases potential thereof much faster than such tab voltage may otherwise be increased by a power supply of integrated circuit 100. Since the capacitance/charge is locally available, the response to droop is relatively quicker without requiring additional resources.

Decision circuit 130 includes a sensing circuit 132 and a timer-controlled comparator module 134. Decision circuit 130 is a multi-channel circuit, and each channel includes a low-pass filter (associated with sensing circuit 132) of a tab voltage and a time-controlled comparator (associated with comparator module 134) of the average and instantaneous values of the tab voltage. Decision circuit 130 monitors voltages of voltage tabs 112₁ and 112₂ of voltage island 110 as well as voltages of voltage tabs 122₁ and 122₂ of voltage island 120. Based on the monitored voltage values, decision circuit 130 dynamically controls the states of control gate 140 accordingly.

During operation, sensing circuit 132 determines an average voltage value of voltage tabs 112₁ and 112₂. In turn, comparator module 134 compares the average and instantaneous voltage values of voltage tabs 112₁ and 112₂, and dynamically controls the ON/OFF states of control gate 140. Being disposed on the same chip with voltage islands 110 and 120, decision circuit 130 provides a fast response to voltage fluctuations at voltage tabs 112₁ or 112₂ that are caused by mid-frequency noise as well as other sources of voltage transients within integrated circuit 100.

If the voltage at one of voltage tabs 112₁, 112₂ of voltage island 110 decreases below a pre-determined threshold TH1, decision circuit 130 enables control gate 140 to couple that tab to a respective one of voltage tabs 121₂, 122₂ of voltage island 120 for a pre-selected time interval ΔT. For example, when the voltage at voltage tab 112₁ (or voltage tab 112₂) momentarily decreases below a pre-determined threshold TH1, decision circuit 130 sets gate 140₁ (or gate 140₂) to an ON state in order to couple voltage tab 112₁ (or voltage tab 112₂) to voltage tab 122₁ (or voltage tab 122₂) for a pre-selected time interval ΔT.

During the pre-selected time interval ΔT, charge accumulated by capacitor 124₁ or capacitor 124₂ (i.e., charge accumulated by the discrete charge storage elements associated with voltage tab 122₁ or voltage tab 122₂) instantaneously discharges into voltage tab 112₁ or voltage tab 112₂, causing the voltage to increase the pre-determined threshold TH1. As soon as the discrete charge storage elements associated with voltage tab 122₁ or voltage tab 122₂ have restored at least a portion of their charge, such process may be repeated, thus resulting in continuous suppression of the mid-frequency noise at voltage tab 122₁ or voltage tab 122₂. The duration of the pre-selected time interval ΔT is determined by the time needed to discharge equivalent capacitor 124₁ or 124₂ into a respective voltage tab of voltage island 110, and should be approximately 1 to 20 ns. The duration of pre-selected time interval ΔT can be controlled by a timer 138 provided within comparator module 134.

Various parameters of sensing circuit 132, comparator module 134, or control gate 140 are programmable. Preferably, the duration of pre-selected time interval ΔT for coupling the voltage tabs and parameters of low-pass filters of sensing circuit 132 or parameters of time-controlled comparators of comparator module 134 may be programmed to achieve the best suppression of the mid-frequency noise within integrated circuit 100.

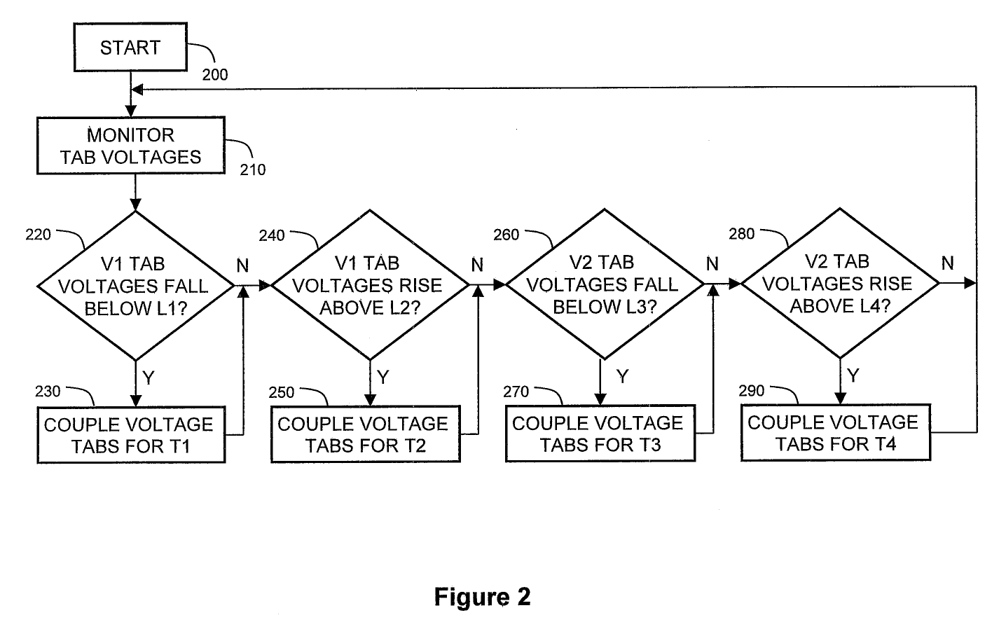

With reference now to FIG. 2, there is illustrated a high-level logic flow diagram of a method for suppressing mid-frequency noise in an integrated circuit, such as integrated circuit 100 from FIG. 1, in accordance with a preferred embodiment of the present invention. Starting at block 200, voltages at a V1 voltage tab powered by a lower rail voltage and voltages at a V2 voltage tab powered by a higher rail voltage are monitored, as shown in block 210. A determination is made whether or not voltages at V1 voltage tab have decreased below a first pre-determined threshold L1, as depicted in block 220. If the voltages at V1 voltage tab have not decreased below first pre-determined threshold L1, another determination is then made whether or not voltages at V1 voltage tab have exceeded above a second pre-determined threshold L2, as depicted in block 240. However, if the voltages at V1 voltage tab have decreased below first pre-determined threshold L1, the decision circuit enables a corresponding gate to couple V1 voltage tab to V2 voltage tab for a first time interval T1 to provide charge to V1 voltage tab, as shown in block 230.

If the voltages at V1 voltage tab have not exceeded above second pre-determined threshold L2, another determination is then made whether or not voltages at V2 voltage tab have decreased below a third pre-determined threshold L3, as depicted in block 260. However, if the voltages at V1 voltage tab have exceeded above second pre-determined threshold L2, the decision circuit enables a corresponding gate to couple V1 voltage tab to V2 voltage tab for a second time interval T1, as shown in block 250. During time interval T1, the charge accumulated by discrete charge storage elements associated with V1 voltage tab is discharged into V2 voltage tab.

If the voltages at V2 voltage tab have not decreased below third pre-determined threshold L3, another determination is then made whether or not voltages at V2 voltage tab have exceeded above a fourth pre-determined threshold L4, as depicted in block 280. However, if the voltages at V2 voltage tab have decreased below third pre-determined threshold L3, the decision circuit enables a corresponding gate to couple V2 voltage tab to V1 voltage tab for a third time interval T3 to provide charge to V2 voltage tab, as shown in block 270.

If the voltages at V2 voltage tab have not exceeded above fourth pre-determined threshold L4, the process returns to block 210. However, if the voltages at V2 voltage tab have exceeded above fourth pre-determined threshold L4, the decision circuit enables a corresponding gate to couple V2 voltage tab to V1 voltage tab for a fourth time interval T4 to bleed excess charge from V2 tab, as shown in block 290.

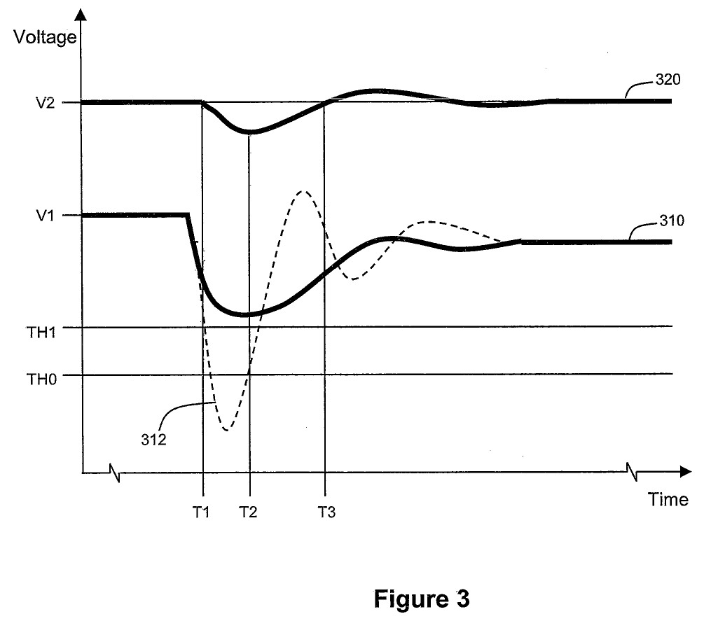

Referring now to FIG. 3, there is depicted a timing diagrams illustrating various tab voltages within integrated circuit 100 from FIG. 1. In particular, graphs 310 and 320 show voltages V1 and V2 at the voltage tabs 112₁ (or 112₂) and 122₁ (or 122₂) as a function of time, respectively. For example, at T1, an event like simultaneous switching of multiple transistors in voltage island 110 generates an impulse of mid-frequency noise that causes voltage V1 at voltage tab 112₁ (or 112₂) to droop. In a conventional integrated circuit, such an event could result in momentarily decreasing of the tab voltage below a critical level TH0, as shown by a dash line 312.

For integrated circuit 100, if the voltage at voltage tab 112₁ (or 112₂) decreases below the pre-determined threshold TH1, decision circuit 130 sets gate 140₁ (or 140₂) temporarily to a conducting state to couple tab 112₁ (or tab 112₂) to tab 112₁ (or tab 112₂) for a pre-selected time interval ΔT=T2−T1.

The resulting discharge of capacitor 124₁ (or 124₂) into voltage tab 122₁ (or 122₂) through conducting gate 140₁ (or 140₂) prevents decreasing of the voltage at voltage tab 112₁ (or 112₂) below the pre-determined threshold TH1. After the re-charging of capacitor 124₁ (or 124₂) has been completed (e.g., about 5-100 ns after expiration of the pre-selected time interval ΔT), the same process may be repeated (illustratively, starting from T3).

As has been described, the present invention provides an apparatus for suppressing mid-frequency noise in an integrated circuit having multiple voltage islands. Although an integrated circuit having only two voltage islands is utilized to illustrate the present invention, it is understood by those skilled in the art that similar arrangements can be utilized to suppress mid-frequency noise in an integrated circuit having more than two voltage islands.

While the invention has been particularly shown and described with reference to a preferred embodiment, it will be understood by those skilled in the art that various changes in form and detail may be made therein without departing from the spirit and scope of the invention.

What is claimed is:

1. An apparatus for suppressing mid-frequency noise in an integrated circuit having a first and second voltage islands, said apparatus comprising:
a sensing circuit for monitoring voltages at a voltage tab of a first voltage rail associated with said first voltage island and voltages at a voltage tab of a second voltage rail associated with said second voltage island;
a control gate capable of connecting said voltage tab of said first voltage rail to a voltage tab of a second voltage rail associated with said second voltage island, wherein said first voltage rail is powered by a lower average voltage than said second voltage rail; and
a decision circuit for enabling said control gate to couple said two voltage tabs
for a first time interval when voltages at said voltage tab of said first voltage rail have decreased below a first pre-determined threshold;
for a second time interval when voltages at said voltage tab of said first voltage rail have exceeded a second pre-determined threshold;
for a third time interval when voltages at said voltage tab of said second voltage rail have decreased below a third pre-determined threshold; and
for a fourth time interval when voltages at said voltage tab of said second voltage rail have exceeded a fourth pre-determined threshold.

2. The apparatus of claim 1, wherein said sensing circuit determines an average value of said voltages at said voltage tab of said first voltage rail.

3. The apparatus of claim 2, wherein said sensing circuit further includes a low path filter of said voltages at said voltage tab of said first voltage rail.

4. The apparatus of claim 1, wherein said decision circuit further includes a comparator for comparing average and instantaneous values of said voltages.

5. The apparatus of claim 4, wherein said decision circuit is a programmable circuit.

6. A method for suppressing mid-frequency noise in an integrated circuit having a first and second voltage islands, said method comprising:
monitoring voltages at a voltage tab of a first voltage rail associated with said first voltage island and a voltage tab of a second voltage rail associated with said second voltage island, wherein said first voltage rail is powered by a lower average voltage than said second voltage rail;
in response to a determination that voltages at said voltage tab of said first voltage rail have decreased below a first pre-determined threshold, connecting said voltage tabs for a first time interval;
in response to a determination that voltages at said voltage tab of said first voltage rail have exceeded a second pre-determined threshold, connecting said voltage tabs for a second time interval;
in response to a determination that voltages at said voltage tab of said second voltage rail have decreased below a third predetermined threshold, connecting said voltage tabs for a third time interval; and
in response to a determination that voltages at said voltage tab of said second voltage rail have exceeded a fourth pre-determined threshold, connecting said voltage tabs for a fourth time interval.

7. The method of claim 6, wherein said monitoring includes comparing instantaneous and average voltages of said voltage tab of said first voltage rail.
